(19) United States
(12) Patent Application Publication
(10) Pub. No.: US 2023/0172352 A1
(43) Pub. Date: Jun. 8, 2023

(54) Under Cabinet Shelf Assembly

(71) Applicant: Chandra Carney, La Porte, IN (US)

(72) Inventor: Chandra Carney, La Porte, IN (US)

(21) Appl. No.: 17/544,132

(22) Filed: Dec. 7, 2021

(51) Int. Cl. A47B 43/00; F16M 13/02

(52) U.S. Cl. CPC A47B 43/003; F16M 13/02

(57) ABSTRACT

An under cabinet shelf assembly for includes a panel that is mountable on an underside of a wall mounted cabinet. A shelf is provided and the shelf is hingedly disposed on the panel. The shelf is positionable in a deployed position having the shelf extending downwardly from the panel. In this way a recipe book can be positioned on the shelf such that the recipe book is visible to a user. The shelf is positionable in a stored position having the shelf lying against the panel. A first magnet is coupled the panel and a second magnet is coupled to the shelf. The second magnet magnetically engages the first magnet when the shelf is in the stored position for retaining the shelf in the stored position.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to shelf devices and more particularly pertains to a new shelf device for supporting a recipe book beneath a wall mounted cabinet. The device includes a panel that is mountable to an underside of the wall mounted cabinet and a shelf that is hingedly coupled to the shelf. The shelf is oriented at right angle with respect to the panel when the shelf is in the deployed position and the shelf lies on a plane that is coplanar with the panel when the shelf is in the stored position.

### (2) Description of Related Art including information disclosed under 37 CFR 1.97 and 1.98

The prior art relates to shelf devices including a variety of cabinet mounted shelves that include a shelf that is mounted to a support panel in a cantilevered fashion. The prior art discloses an under cabinet shelf device that includes a panel and the shelf that is pivotally disposed on the panel. The shelf includes pegs which slidably engage slots in the panel for positioning the shelf between a deployed position and a stored position. The prior art discloses an under cabinet shelf that includes scissor arms that engage an underside of a cabinet. The prior art discloses an under cabinet shelf device that includes a shelf which has a slot integrated into the shelf for retaining a planar object on the shelf.

### BRIEF SUMMARY OF THE INVENTION

An embodiment of the disclosure meets the needs presented above by generally comprising a panel that is mountable on an underside of a wall mounted cabinet. A shelf is provided and the shelf is hingedly disposed on the panel. The shelf is positionable in a deployed position having the shelf extending downwardly from the panel. In this way a recipe book can be positioned on the shelf such that the recipe book is visible to a user. The shelf is positionable in a stored position having the shelf lying against the panel. and A first magnet is coupled the panel and a second magnet is coupled to the shelf. The second magnet magnetically engages the first magnet when the shelf is in the stored position for retaining the shelf in the stored position.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a under cabinet shelf assembly according to an embodiment of the disclosure.

FIG. 2 is a top view of an embodiment of the disclosure.

FIG. 3 is a front phantom view of an embodiment of the disclosure.

FIG. 4 is a right side view of an alternative embodiment of the disclosure showing a shelf in a deployed position.

FIG. 5 is a right side view of an alternative embodiment of the disclosure showing a shelf in a stored position.

FIG. 6 is a perspective in-use view of an embodiment of the disclosure.

### DETAILED DESCRIPTION OF THE INVENTION

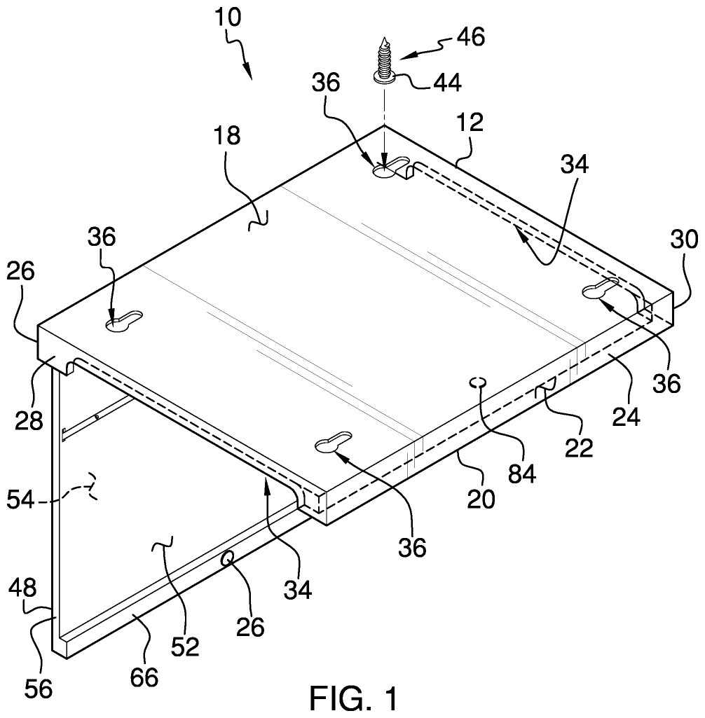

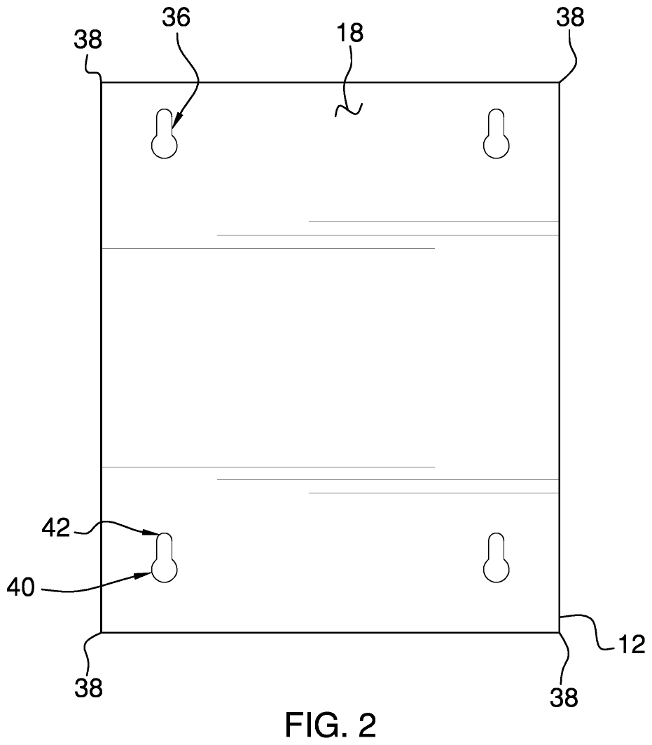

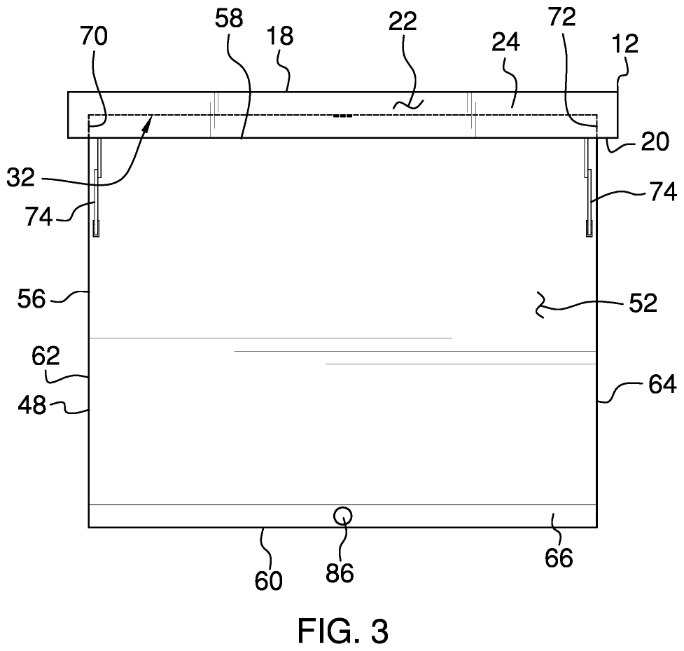

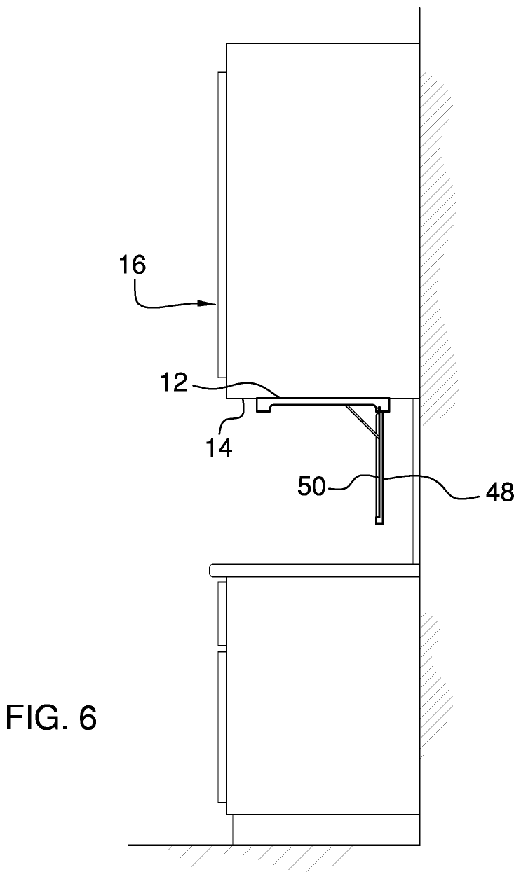

With reference now to the drawings, and in particular to FIGS. 1 through 6 thereof, a new shelf device embodying the principles and concepts of an embodiment of the disclosure and generally designated by the reference numeral 10 will be described.

As best illustrated in FIGS. 1 through 6, the under cabinet shelf assembly 10 generally comprises a panel 12 that is mountable on an underside 14 of a wall mounted cabinet 16. The wall mounted cabinet 16 may be positioned in a kitchen or other area where food is commonly cooked. The panel 12 has a top surface 18, a bottom surface 20 and a perimeter surface 22 extending between the top surface 18 and the bottom surface 20. The perimeter surface 22 has a front side 24, a back side 26, a first lateral side 28 and a second lateral side 30. The bottom surface 20 has a recessed portion 32 extending toward the top surface 18 and the recessed portion 32 is spaced from the perimeter surface 22. Each of the first lateral side 28 and the second lateral side 30 has a channel 34 extending into the recessed portion 32. The channel 34 on each of the first lateral side 28 and the second lateral side 30 extends substantially between the front side 24 and the back side 26.

The panel 12 has a plurality of fastener apertures 36 each extending through the recessed portion 32 of the bottom surface 20 and the top surface 18 and each of the fastener apertures 36 is aligned with a respective one of four corners 38 of the panel 12. Each of the fastener apertures 36 has a first section 40 and a second section 42. The first section 40 is rounded and the second section 42 has an ovoid shape which has a width that is less than a diameter of the first section 40. In this way the first section 40 can accommodate a head 44 of a fastener 46 which engages the underside 14 of the wall mounted cabinet 16. Moreover, the head 44 of the fastener 46 is slidable into the second section 42 thereby retaining the panel 12 on the wall mounted cabinet 16 having the top surface 18 abutting the underside 14 of the wall mounted cabinet 16.

A shelf 48 is hingedly disposed on the panel 12 and the shelf 48 is positionable in a deployed position having the shelf 48 extending downwardly from the panel 12. In this way a recipe book 50 can be positioned on the shelf 48 such that the recipe book 50 is visible to a user. The recipe book 50 might be displayed on an electronic device, such as a tablet, or the recipe book 50 might be a printed book. In either case, the recipe book 50 is a planar object that can rest on the shelf 48. The shelf 48 is positionable in a stored position having the shelf 48 lying against the panel 12. The shelf 48 may be oriented at a right angle with respect to the panel 12 when the shelf 48 is in the deployed position. Additionally, the shelf 48 may travel between lying on a plane that is coplanar with the panel 12 and being oriented at a right angle with the panel 12 when the shelf 48 is moved between the deployed position and the stored position.

The shelf 48 has a first surface 52, a second surface 54 and an outer edge 56 extending between the first surface 52 and the second surface 54, and the outer edge 56 has a rear side 58, a forward side 60, a first sidelong side 62 and a second sidelong side 64. The first surface 52 has a lip 66 extending away from the first surface 52. The lip 66 is aligned with and is coextensive with the forward side 60 of the outer edge 56 to support the recipe book 50 when the recipe book 50 is positioned on the first surface 52. Each of the first sidelong side 62 and the second sidelong side 64 has a pivot point 68 that is positioned adjacent to the rear side 58 of the outer edge 56. The pivot point 68 on each of the first sidelong side 62 and the second sidelong side 64 pivotally engages a respective one of a first lateral bounding surface 70 and a second lateral bounding surface 72 of the recessed portion 32 of the bottom surface 20 of the panel 12 at point that is located adjacent to the back side 26 of the perimeter surface 22 of the panel 12. The shelf 48 is positioned in the recessed portion 32 of the bottom surface 20 of the panel 12 when the shelf 48 is in the stored position.

A pair of supports 74 is provided and each of the supports 74 has a first section 76 that is hingedly coupled to a second section 78. Each of the supports 74 has a first end 80 and a second end 82; the first end 80 is associated with the first section 76 of the supports 74 and the second end 82 is associated with the second section 78 of the supports 74. The first end 80 of each of the supports 74 is recessed into the first surface 52 of the shelf 48 having the first end 80 of each of the supports 74 pivotally engaging the shelf 48. The second end 82 of each of the supports 74 is recessed into the recessed portion 32 of the bottom surface 20 of the panel 12 having the second end 82 of each of the supports 74 pivotally engaging the panel 12. Each of the supports 74 is elongated to extend between the shelf 48 and the panel 12 when the shelf 48 is positioned in the deployed position. Additionally, the first section 76 and the second section 78 of each of the supports 74 is folded when the shelf 48 is positioned in the stored position.

A first magnet 84 is disposed on the panel 12 and the first magnet 84 is positioned on the recessed portion 32 of the bottom surface 20. The first magnet 84 is positioned adjacent to the front side 24 of the perimeter surface 22, and the first magnet 84 is centrally positioned between the first lateral side 28 and the second lateral side 30 of the perimeter surface 22 of the panel 12. A second magnet 86 is coupled to the shelf 48 and the second magnet 86 magnetically engages the first magnet 84 when the shelf 48 is in the stored position for retaining the shelf 48 in the stored position. The second magnet 86 is positioned on a distal surface 88 of the lip 66 on the first surface 52 of the shelf 48 and the second magnet 86 is centrally positioned between first sidelong side 62 and the second sidelong side 64 of the shelf 48.

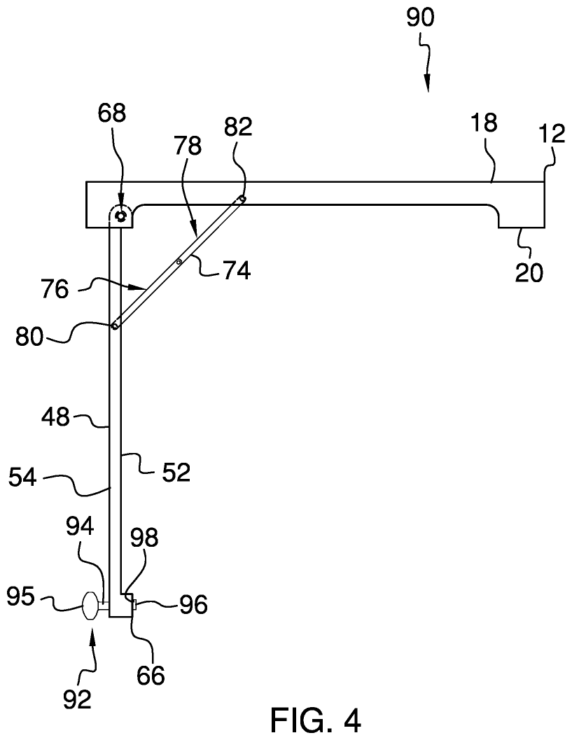

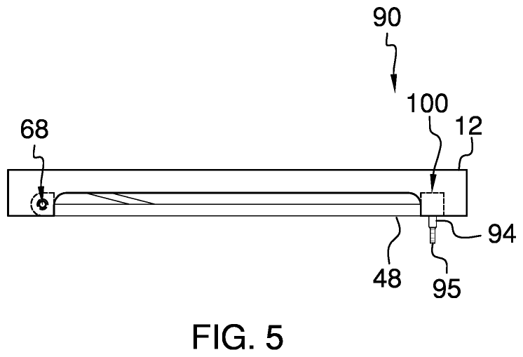

In an alternative embodiment 90 as is most clearly shown in FIGS. 4 and 5, a lock 92 is rotatably integrated into the shelf 48. The lock 92 comprises a stem 94 extending through the first surface 52 and the second surface 54 of the shelf 48. Additionally, the lock 92 includes a head 95 that is coupled to the stem 94. The head 95 is spaced from the second surface 54 of the shelf 48 such that the head 95 can be gripped.

The stem 94 includes a foot 96 that is disposed on a distal end 98 of the stem 94 with respect to the head 95. The foot 96 is spaced from the first surface 52 of the shelf 48 and the foot 96 engages an engagement point 100 that is integrated into the panel 12 when the lock 92 is rotated into a locked position for retaining the shelf 48 in the stored position. Conversely, the foot 96 disengages the engagement point 100 when the lock 92 is rotated into an unlocked position to facilitate the shelf 48 to be positioned in the deployed position.

In use, the panel 12 is mounted to the underside 14 of the wall mounted cabinet 16. The shelf 48 is positioned in the deployed position to support the recipe book 50. In this way the recipe book 50 is visible to a cook while the cook is following a recipe in the recipe book 50. Additionally, the recipe book 50 can be employed in a hands free manner while the cook is following the recipe in the recipe book 50. The shelf 48 is positioned in the stored position when the recipe book 50 is not positioned on the shelf 48.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. An under cabinet shelf assembly for supporting an electronic device beneath a cabinet, said assembly comprising:
a panel being mountable on an underside of a wall mounted cabinet;
a first magnet being disposed on said panel;
a shelf being hingedly disposed on said panel, said shelf being positionable in a deployed position having said shelf extending downwardly from said panel wherein said shelf is configured to have a recipe book being positioned thereon such that the recipe book is visible to a user, said shelf being positionable in a stored position having said shelf lying against said panel, said shelf having a first surface, a second surface and an outer edge extending between said first surface and said second surface, said outer edge having a rear side, a forward side, a first sidelong side and a second sidelong side, said first surface having a lip extending away from said first surface, said lip being aligned with and being coextensive with said forward side of said outer edge wherein said lip is configured to support the recipe book when the recipe book is positioned on said first surface; and
a second magnet being coupled to said shelf, said second magnet being positioned on and flush with a distal surface of said lip parallel to said first surface, said second magnet being aligned with said first magnet for magnetically engaging said first magnet when said shelf is in said stored position for retaining said shelf in said stored position.

2. The assembly according to claim 1, wherein:
said panel has a top surface, a bottom surface and a perimeter surface extending between said top surface and said bottom surface, said perimeter surface having a front side, a back side, a first lateral side and a second lateral side, said bottom surface having a recessed portion extending toward said top surface, said recessed portion being spaced from said perimeter surface, each of said first lateral side and said second lateral side having a channel extending into said recessed portion, said channel on each of said first lateral side and said second lateral side extending substantially between said front side and said back side;
said panel has a plurality of fastener apertures each extending through said recessed portion of said bottom surface and said top surface, each of said fastener apertures being aligned with a respective one of four corners of said panel, each of said fastener apertures having a first section and a second section, said first section being rounded, said second section having an ovoid shape having a width being less than a diameter of said first section wherein said first section is configured to accommodate a head of a fastener which engages the underside of the wall mounted cabinet such that the head of the fastener is slidable into said second section thereby retaining said panel on the wall mounted cabinet having said top surface abutting the underside of the wall mounted cabinet.

3. The assembly according to claim 2, wherein
each of said first sidelong side and said second sidelong side has a pivot point being positioned adjacent to said rear side of said outer edge, said pivot point on each of said first sidelong side and said second sidelong side pivotally engaging a respective one of a first lateral bounding surface and a second lateral bounding surface of said recessed portion of said bottom surface of said panel at point being located adjacent to said back side of said perimeter surface of said panel, said shelf being positioned in said recessed portion of said bottom surface of said panel when said shelf is in said stored position.

4. The assembly according to claim 3, wherein:
said assembly includes a pair of supports, each of said supports having a first section being hingedly coupled to a second section, each of said supports having a first end and a second end, said first end being associated with said first section of said supports, said second end being associated with said second section of said supports;
said first end of each of said supports is recessed into said first surface of said shelf having said first end of each of said supports pivotally engaging said shelf;
said second end of each of said supports is recessed into said recessed portion of said bottom surface of said panel having said second end of each of said supports pivotally engaging said panel; and
each of said supports is elongated to extend between said shelf and said panel when said shelf is positioned in said deployed position, said first section and said second section of each of said supports being folded when said shelf is positioned in said stored position.

5. The assembly according to claim 2, wherein:
said shelf has a first surface, a first sidelong side and a second sidelong side, said first surface having a lip extending away from said first surface;
said first magnet is positioned on said recessed portion of said bottom surface of said panel, said first magnet being positioned adjacent to said front side of said perimeter surface, said first magnet being centrally positioned between said first lateral side and said second lateral side of said perimeter surface of said panel; and said second magnet being centrally positioned between first sidelong side and said second sidelong side of said shelf.

6. An under cabinet shelf assembly for supporting an electronic device beneath a cabinet, said assembly comprising:
a panel being mountable on an underside of a wall mounted cabinet, said panel having a top surface, a bottom surface and a perimeter surface extending between said top surface and said bottom surface, said perimeter surface having a front side, a back side, a first lateral side and a second lateral side, said bottom surface having a recessed portion extending toward said top surface, said recessed portion being spaced from said perimeter surface, each of said first lateral side and said second lateral side having a channel extending into said recessed portion, said channel on each of said first lateral side and said second lateral side extending substantially between said front side and said back side, said panel having a plurality of fastener apertures each extending through said recessed portion of said bottom surface and said top surface, each of said fastener apertures being aligned with a respective one of four corners of said panel, each of said fastener apertures having a first section and a second section, said first section being rounded, said second section having an ovoid shape having a width being less than a diameter of said first section wherein said first section is configured to accommodate a head of a fastener which engages the underside of the wall mounted cabinet such that the head of the fastener is slidable into said second section thereby retaining said panel on the wall mounted cabinet having said top surface abutting the underside of the wall mounted cabinet;
a first magnet being disposed on said panel, said first magnet being positioned on said recessed portion of said bottom surface, said first magnet being positioned adjacent to said front side of said perimeter surface, said first magnet being centrally positioned between said first lateral side and said second lateral side of said perimeter surface of said panel;
a shelf being hingedly disposed on said panel, said shelf being positionable in a deployed position having said shelf extending downwardly from said panel wherein said shelf is configured to have a recipe book being positioned thereon such that the recipe book is visible to a user, said shelf being positionable in a stored position having said shelf lying against said panel, said shelf having a first surface, a second surface and an outer edge extending between said first surface and said second surface, said outer edge having a rear side, a forward side, a first sidelong side and a second sidelong side, said first surface having a lip extending away from said first surface, said lip being aligned with and being coextensive with said forward side of said outer edge wherein said lip is configured to support the recipe book when the recipe book is positioned on said first surface, each of said first sidelong side and said second sidelong side having a pivot point being positioned adjacent to said rear side of said outer edge, said pivot point on each of said first sidelong side and said second sidelong side pivotally engaging a respective one of a first lateral bounding surface and a second lateral bounding surface of said recessed portion of said bottom surface of said panel at point being located adjacent to said back side of said perimeter surface of said panel, said shelf being positioned in said recessed portion of said bottom surface of said panel when said shelf is in said stored position;
a pair of supports, each of said supports having a first section being hingedly coupled to a second section, each of said supports having a first end and a second end, said first end being associated with said first section of said supports, said second end being associated with said second section of said supports, said first end of each of said supports being recessed into said first surface of said shelf having said first end of each of said supports pivotally engaging said shelf, said second end of each of said supports being recessed into said recessed portion of said bottom surface of said panel having said second end of each of said supports pivotally engaging said panel, each of said supports being elongated to extend between said. shelf and said panel when said shelf is positioned in said deployed position, said first section and said second section of each of said supports being folded when said shelf is positioned in said stored position; and
a second magnet being coupled to said shelf, said second magnet being positioned on and flush with a distal surface of said lip parallel to said first surface of said shelf, said second magnet being centrally positioned between first sidelong side and said second sidelong side of said shelf, said second magnet being aligned with said first magnet for magnetically engaging said first magnet when said shelf is in said stored position for retaining said shelf in said stored position.

7. The assembly according to claim 6, further comprising a lock being rotatably integrated into said shelf, said lock comprising a stem extending through said first surface and said second surface of said shelf, said lock including a head being coupled to said stem, said head being spaced from said second surface of said shelf wherein said head is configured to be gripped, said stem having a foot being disposed on a distal end of said stem with respect to said head, said foot. being spaced from said first surface of said shelf, said foot engaging an engagement point being integrated into said panel when said lock is rotated into a. locked position for retaining said shelf in said stored position, said foot disengaging said engagement point when said lock is rotated into an unlocked position to facilitate said shelf to be positioned in said deployed position.
